(19) United States
(12) Patent Application Publication
(10) Pub. No.: US 2013/0332568 A1
(43) Pub. Date: Dec. 12, 2013

(54) METHOD OF DATA PROCESSING BY A NAVIGATION MODULE

(71) Applicant: France Telecom, Paris (FR)

(72) Inventors: JEROME GIRAUD, Caen (FR); Sylvain Lalande, Bauquay (FR)

(21) Appl. No.: 13/914,457

(22) Filed: Jun. 10, 2013

(30) Foreign Application Priority Data
Jun. 11, 2012 (FR) 1255446

(51) Int. Cl. H04L 29/08

(52) U.S. Cl. CPC H04L 29/0809
USPC 709/217

(57) ABSTRACT

A distributed method of processing data in a navigation module, having a local database allowing recording and access to data recorded by one or more modules suitable for being loaded into the navigation module and belonging to the same common navigation domain is disclosed. In one aspect, the method comprises loading a first Web page and a first work module associated with the first Web page and belonging to the common navigation domain, processing by the first work module, according to a set of instructions of a set of data to be processed. During an interruption, an intermediate result is stored in the local database. Subsequent to the loading of a new Web page, a new work module belonging to the common navigation domain is loaded and resumes the processing of the data to be processed according to the remaining instructions until obtaining a final result.

### RELATED APPLICATIONS

This application claims priority to French Patent Application No. 1255446, filed Jun. 11, 2012, the entire contents of which are incorporated by reference in their entirety and for all purposes.

### BACKGROUND OF THE INVENTION

1. Field of the Invention

The invention relates to the distributed processing of data in a communications network.

2. Description of the Related Technology

The technology of “Grid Computing” type makes it possible to use distributed resources to perform one or more unwieldy data processing jobs faster than if these processing jobs were performed by a single terminal. “Grid Computing” consists in distributing over a large number of client terminals of a distributed system the processing jobs to be performed.

The principle is to use the resources not used by the users of the client terminals. The processing jobs can thus be performed as a background task without impacting the user of a client terminal.

Accordingly, it is necessary for each client terminal to locally download the data and processing commands to be performed, for example in the form of dedicated software to be executed. This technology therefore requires the participation of the users of the client terminals. When they are not deriving any direct benefit from the use of the resources of their terminal, users often have a tendency to deactivate, or indeed to delete the dedicated software, thereby diminishing the processing performance of the distributed “Grid Computing” system.

There therefore exists a need to simplify the deployment of “Grid Computing” technology which does not require the participation of the users of client terminals belonging to the distributed system.

The HTML5 (for HyperText Markup Language 5 in English) standard, used for the implementation of Internet pages, comprises an implementation of a “Web workers” mechanism. This “Web workers” mechanism allows an Internet browser implementing the HTML5 standard to execute, in parallel, processing jobs defined with the aid of “threads” defined in the Internet page downloaded by the Internet browser.

“Web workers” technology can thus be used to implement a distributed “Grid Computing” system by outsourcing the data processing jobs to be performed to a “Web worker”. For example, when a user connects to an Internet page www.a.fr of a navigation domain, his browser downloads from the server of the navigation domain, at the same time as the Internet page, the “Web worker” defined in this page containing the data and processing commands to be performed by his terminal. The terminal performs the data processing without impacting the user's browsing in the downloaded Internet page or the navigation domain. When the data processing has terminated, the Internet browser returns the result of the processing to the server.

However, the data processing time available is limited by the user's browsing time on the navigation domain of the downloaded Internet page. Thus, if the user closes his connection to the navigation domain before the data processing to be performed has terminated, the processing is abandoned and the result will never be uploaded to the server. The server will then be idle while awaiting results and the use of the user terminal's resources will not have been useful. This can also pose problems at the level of the distribution of the processing jobs to be performed by the server. For lengthy processing jobs, it requires very fine apportioning of the “Grid Computing” processing jobs to be performed for fairly short processing times. This may reduce the beneficial gain in calculation time afforded by distributing the processing jobs, for example because of the increase in the volume of data to be transmitted to the client terminal in order to perform the processing, and therefore a lengthening of the transmission time for these data.

This simple implementation of “Grid Computing” by a “Web worker” is not suitable for all applications which could benefit from the advantages of “Grid Computing”.

### SUMMARY OF CERTAIN INVENTIVE ASPECTS

The aim of various embodiments is to afford improvements with respect to the prior art.

One aspect is a method of processing data in a navigation module. The navigation module has a local database allowing recording and access to data recorded by one or more modules suitable for being loaded into the navigation module and belonging to one and the same common navigation domain. The method of processing data comprises the steps of:
loading by the navigation module of a first Web page,
loading into the navigation module of a first work module associated with the first Web page and belonging to the common navigation domain,
obtaining by the first work module of a group of data processing instructions and of a group of data to be processed on the basis of a server belonging to the common navigation domain,
processing by the first work module, according to at least one instruction of the group of instructions of at least one data item of the group of data to be processed,
storage by the first work module, in the local database, of at least one remaining instruction still to be executed and of at least one intermediate result data item obtained by the processing of the at least one data item to be processed,
subsequent to the loading by the navigation module of a new Web page, and to the loading into the navigation module of a new work module associated with the new Web page and belonging to the common navigation domain, processing of the at least one intermediate result data item, according to at least the stored remaining instruction,
the steps of storage, of loading of a new Web page, of loading of a new work module and of processing being repeated until the obtaining of a final result obtained when all the instructions of the group of instructions have been executed and,
dispatching of the final result to the server belonging to the common navigation domain.

The method according to some aspects thus makes it possible to easily perform data processing jobs in a distributed manner suitable for any application. The length of each distributed task is not impacted by intentional or unintentional interruptions of the user of the terminal on which the task is executed. The resources, the apportioning into tasks and the distributing of the processing jobs are thus optimized.

The various modes or characteristics of embodiment mentioned hereinafter may be added independently or in combination with one another, to the steps of the above-defined method.

According to a particular embodiment of the invention, the first Web page and/or the new Web page belongs to a navigation domain distinct from the common navigation domain.

The data processing can thus be distributed by an independent “Grid Computing” service, different from the navigation domain consulted by the user. The method according to the invention thus makes it possible to distribute the processing jobs in a generic manner, without being tied to a particular consulted navigation domain.

According to another particular embodiment of the invention, the first Web page belongs to a navigation domain distinct from the navigation domain of the new Web page.

The method according to one aspect of the invention thus makes it possible to perform data processing jobs in a distributed manner without the distribution of the processing jobs being limited to a single navigation domain. The data processing can thus be relaunched on the basis of the consultation of a user from among a great diversity of navigation domain, or of different Internet sites.

According to another particular embodiment of the invention, the loading of the first work module is brought about by the presence in the first Web page of a reference to the common navigation domain.

The use of the local database associated with the use of a common navigation domain thus makes it possible to share the intermediate result between the first and second work modules. The method according to the invention makes it possible to thus avoid the use of a third-party entity disposed outside the navigation module for the sharing of the intermediate result and the resumption of the processing.

According to another particular embodiment of the invention, the reference to the common navigation domain is contained in another Web page contained in the first Web page, the other Web page containing instructions to be executed by the navigation module allowing the loading of the first work module. This embodiment allows fast development of Web pages by IT engineers and easier reuse.

According to another particular embodiment of the invention, the storage step is brought about by the closing of the first Web page in the navigation module or by the closing of the navigation module. The non-terminated data processing is thus not lost when the user stops the consultation of a Web page that allowed the processing to be launched.

According to another particular embodiment of the invention, the method comprises a step of monitoring in the data stored in the local database, of the end of processing according to the at least one instruction, and a step of obtaining by the new work module of at least one new group of processing instructions if the processing according to the group of instruction has terminated.

The invention also relates to a device for processing data in a navigation module comprising means suitable for implementing the data processing method described previously according to any one of the particular embodiments.

In a particular embodiment, the various steps of the method are determined by instructions of computer programs.

Consequently, the technology is also aimed at computer programs on an information medium, these programs being liable to be implemented respectively in a terminal or more generally in a computer, these programs comprising respectively instructions suitable for the implementation of the various steps of the methods which have just been described.

These programs can use any programming language, and be in the form of source code, object code, or of code intermediate between source code and object code, such as in a partially compiled form, or in any other desirable form.

The technology is also aimed at an information medium readable by a computer, and comprising instructions of a computer program such as mentioned hereinabove.

The information medium can be any entity or device capable of storing the program. For example, the medium can comprise a storage means, such as a ROM, for example a CD ROM or a microelectronic circuit ROM, or else a magnetic recording means, for example a diskette (floppy disk) or a hard disk.

Moreover, the information medium can be a transmissible medium such as an electrical or optical signal, which can be conveyed via an electrical or optical cable, by radio or by other means. The program according to the invention can be in particular downloaded on a network of Internet type.

Alternatively, the information medium can be an integrated circuit into which the program is incorporated, the circuit being adapted for executing or to be used in the execution of the methods in question.

### BRIEF DESCRIPTION OF THE DRAWINGS

Other advantages and characteristics of the invention will be more clearly apparent on reading the following description of a particular embodiment of the invention, given by way of simple illustrative and nonlimiting example, and the appended drawings, among which:

FIG. 1 presents an implementation environment of the invention according to a particular embodiment of the invention,

FIG. 2 presents steps of the method of processing data according to a particular embodiment of the invention,

FIG. 3 presents an architecture of a device making it possible to implement the invention according to a particular embodiment of the invention.

### DETAILED DESCRIPTION OF CERTAIN ILLUSTRATIVE EMBODIMENTS

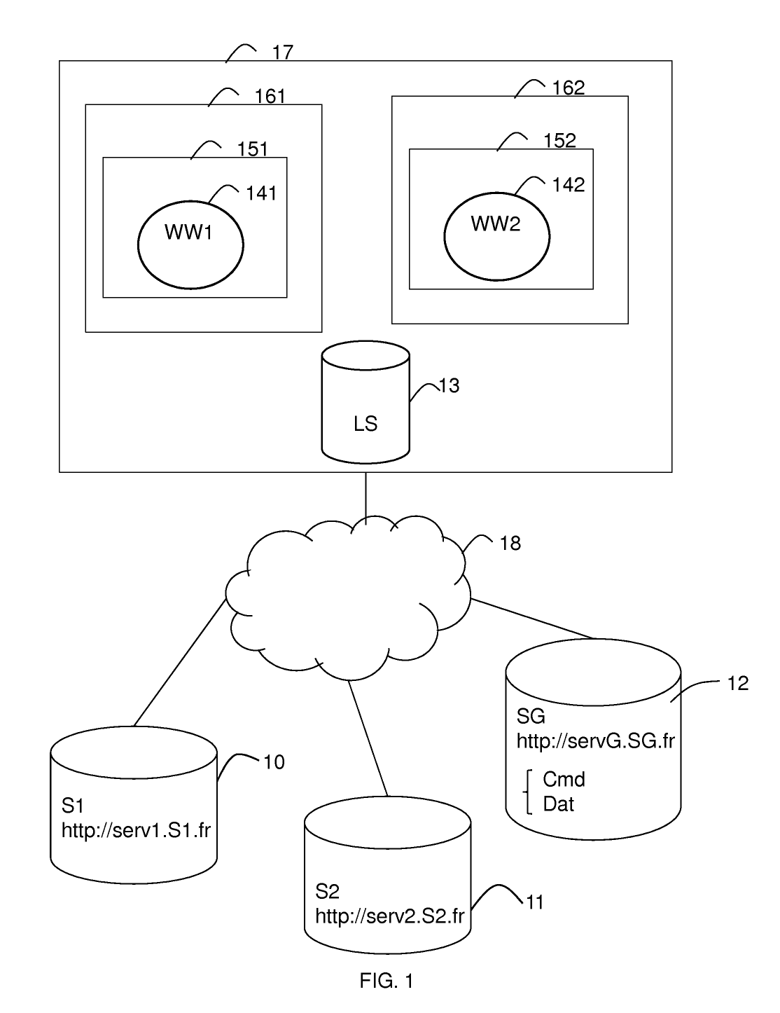

FIG. 1 presents an implementation environment of the invention according to a particular embodiment of the invention. FIG. 1 illustrates a navigation module 17 executed by a terminal (not represented) of a user connected to a telecommunication network 18, for example an IP (for Internet Protocol in English) network. The navigation module is commonly called an Internet browser in everyday parlance.

The function of the navigation module 17 is notably to allow a user to access and to interact with a set of pages of an application. More particularly, the navigation module 17 makes it possible to download Web pages implementing a Web application, these pages belonging to a navigation domain and being provided by a server for managing the navigation domain in question. The navigation module 17 comprises with this aim at least one client able to communicate according to the HyperText Transfer Protocol (in English) (HTTP) with an HTTP remote server. Such pages are described for example in the “Hypertext Markup Language” (in English) (HTML). Page formatting data, dubbed style sheets, usually coded in the CSS (Cascading Style Sheet) format, are appended to this HTML-coded page. The HTML page furthermore contains (or is transmitted with) program codes, usually in the form of Javascript, intended to be interpreted and executed by the navigation module upon the loading of the page.

The navigation module 17 thus comprises an engine for interpreting the HTML code, the formatting data and the program codes, in order to execute the functions coded by the program codes, and then to generate, format and display the downloaded Web pages.

The notion of navigation domain has to be interpreted in the broad sense: it is a Web domain or pages having one and the same domain name. For example, all the pages whose URL contains www.xxxx.fr and/or www.xxxx.com and/or bbb.xxxx.com, where “xxxx” represents the name of the domain in question.

According to a particular embodiment of the invention, the navigation module 17 is for example compatible with the HTML5 (HyperText Markup Language 5) language. It has a local database 13 (LS) allowing recording and access to data recorded by one or more Web pages belonging to a common navigation domain.

The local database 13 stores the data in a storage space of the user's terminal, this storage space being reserved for the navigation module.

Furthermore, the terms “local” and “locally” have to be considered with respect to the navigation module 17 and its components. Thus a locally stored data item corresponds, subsequently, to a data item accessible directly by the navigation module 17, without calling either upon an entity remote from the user's terminal such as a remote Web server, or upon an entity executed in the software environment of the user's terminal but supported by processes that are not initiated by the navigation module 17, such as a database server executed in the software environment in a process not belonging to the navigation module 17.

The navigation module 17 is also able to interpret source code making it possible to instantiate as a background task objects of Web worker type performing operations in the browser in parallel with the Internet browsing of a user of the terminal.

The environment also comprises two servers 10 and 11 hosting Internet sites or Internet pages offering services S1, S2 respectively. The environment also comprises a server 12 comprising a “Grid Computing” service SG. For a given application, the server 12 stores the instructions (Cmd) of the processing jobs to be performed for this application and the data (Dat) to be processed.

For example, the user desires to connect to an Internet site to access a service S1. The service S1 is for example accessible at the address http://www.serv1.S1.fr and is hosted on the server 10 of the telecommunication network. The navigation module 17 then connects to the server 10 and loads a Web page 161 corresponding for example to the home page of the service S1, from the server 10. The Web page 161 belongs to the navigation domain of the service S1. The loading of the Web page is performed by the downloading on the terminal of the user of the source code of the Web page 161. This source code is interpreted by the navigation module so as to display to the user the visual content of the Web page corresponding to the service S1. The downloaded source code also comprises contents which are not intended to be displayed to the user and which are intended to be executed by the navigation module 17 so as to ensure the service S1 or other services.

The source code of the Web page 161 contains a frame 151, otherwise called an iFrame in computer parlance, which is hosted on the “Grid Computing” server 12, for example accessible at the address http://www.servG.SG.fr. The frame 151 belongs to the navigation domain SG of the server 12.

The navigation module 17 loads the content of the frame 151 from the server 12. The content of the frame 151 corresponds to the source code defining the frame 151. This source code contains instructions which make it possible to instantiate a Web worker 141 (WW1) of the navigation module 17. The instructions (Cmd) to be executed by the Web worker 141 are downloaded from the server 12, as is a set of data to be processed (Dat). The frame 151 thus constitutes a container of the Web worker 141.

The Web worker 141 performs the processing of the downloaded data as a background task without impeding the user of the terminal during consultation of the service S1.

When the user closes the Web page 161 or the navigation module 17, the Web worker 141 is killed and the data processing is interrupted. The intermediate result obtained on the interruption of the data processing is saved in the local database 13 of the navigation module 17 by the frame 151. Likewise, the remaining instructions to be executed and the remainder of the data to be processed are also saved in the local database 13.

In a known manner, the local database 13 is partitioned by navigation domain. The data stored by the frame 151 are therefore identified in the local database 13 as belonging to the navigation domain SG of the server 12.

Subsequently, for example the user desires to connect to another Internet site so as to access a service S2, for example accessible at the address http://www.serv2.S2.fr and hosted on the server 11 of the telecommunication network 18. The navigation module 17 then connects to the server 11 and loads a Web page 162 corresponding for example to the home page of the service S2, from the server 11. The Web page 162 belongs to the navigation domain of the service S2.

The source code of the Web page 162 contains a frame 152 which is hosted on the “Grid Computing” server 12. The frame 152 belongs to the navigation domain SG of the server 12.

The navigation module 17 loads the content of the frame 152 from the server 12. This source code contains instructions which allow the frame 152 to retrieve from the local database 13 the intermediate result stored beforehand and to instantiate a Web worker 142 (WW2) of the navigation module 17 in order to resume the data processing according to the remaining stored instructions.

In the case where the data processing performed by the previous Web worker 141 was completed correctly, the frame 152 does not retrieve the intermediate result and downloads from the “Grid Computing” server 12 new instructions and new data to be processed by the Web worker 142.

When all the instructions (Cmd) for processing the data (Dat) have been executed, the final result is returned by the frame 152, or 151 if the processing was completed during the execution by the previous Web worker 141, to the server 12.

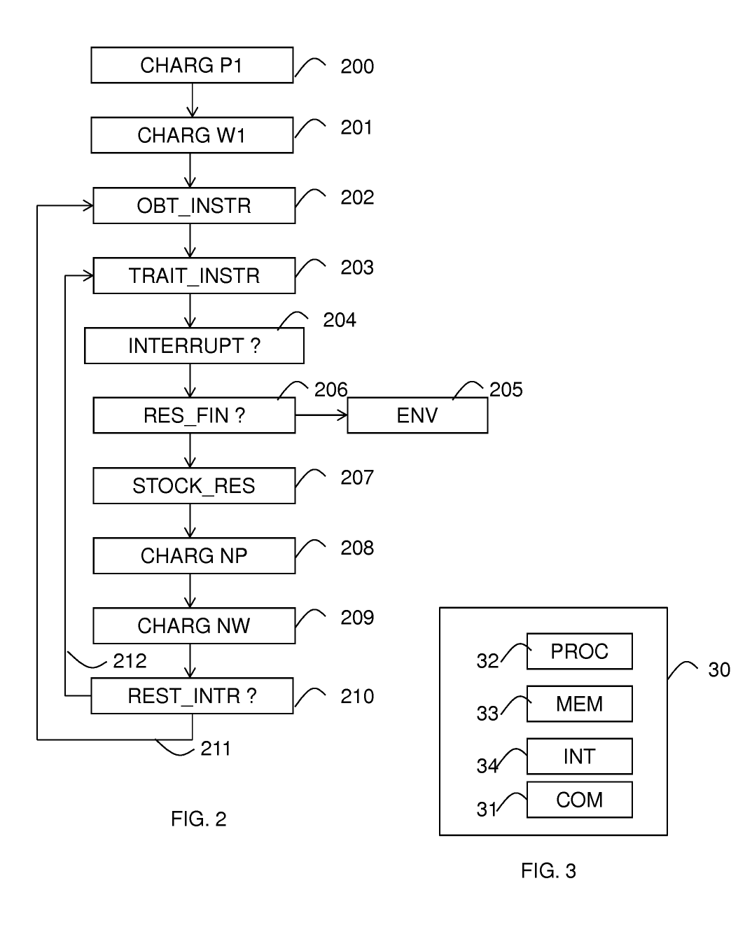

FIG. 2 presents steps of the method of processing data according to a particular embodiment of the invention.

The method of processing data is implemented in a navigation module, for example the navigation module 17 of FIG. 1. The method comprises a step 200 of loading by the navigation module of a first Web page, for example the Internet page 161 of FIG. 1, belonging to a first navigation domain D1.

During a step 201, a first work module is loaded into the navigation module. This first work module is associated with the first Web page and corresponds for example to the Web worker 141 of FIG. 1. The first work module belongs to a navigation domain DW. The first work module may also correspond to a set formed by the Web worker 141 and the frame 151 of FIG. 1.

According to a particular embodiment of the invention, the first Web page belongs to a navigation domain D1 distinct from the navigation domain DW of the first work module.

According to another particular embodiment of the invention, the loading of the first work module is brought about by the presence in the first Web page of a reference to the navigation domain DW.

According to a variant of this particular embodiment of the invention, the reference to the navigation domain DW is contained in another Web page (PWA) contained in the first Web page, for example the frame 151 of FIG. 1. The other Web page (PWA) contains instructions to be executed by the navigation module allowing the loading of the first work module.

During a step 202, the first work module obtains a group of instructions for processing data and a group of data to be processed on the basis of a server belonging to the navigation domain DW, for example the server 12 of FIG. 1. For example, the first work module obtains the instructions and the data to be processed by virtue of the frame 151 of FIG. 1 which loads these data from a server.

During step 203, the first work module performs the processing according to at least one instruction of the group of instructions of at least one data item of the group of data to be processed.

During a step 204, an interruption of the data processing is detected.

If the interruption of the data processing corresponds to the end of the execution of the last instruction to be executed and therefore to the obtaining of a final result arising from the data processing (step 206), the final result is dispatched by the work module to the server belonging to the navigation domain DW.

According to a particular embodiment of the invention, the final result is dispatched to the server by the Web page (PWA) belonging to the navigation domain DW and that allowed the loading of the navigation module.

If during step 206, the interruption of the data processing does not correspond to the obtaining of the final result, an intermediate result obtained by the data processing already performed is stored in the local database of the navigation module, by the first navigation module, during a step 207.

According to a particular embodiment of the invention, the remaining instructions and the data remaining to be processed are also stored in the local database.

According to another particular embodiment of the invention, an information item indicating which instructions and data remaining to be processed is stored in place of the instructions and of the remaining data.

According to a particular embodiment of the invention, the interruption of the data processing is brought about by the closing of the first Web page in the navigation module.

According to another particular embodiment of the invention, this interruption is brought about by the closing of the navigation module.

Subsequent to the loading by the navigation module of a new Web page during a step 208, a new work module is loaded into the navigation module during a step 209. This new work module is associated with the new Web page and corresponds for example to the Web worker 142 of FIG. 1. The new work module belongs to the navigation domain DW. The new work module can also correspond to a set formed by the Web worker 142 and the frame 152 of FIG. 1.

According to a particular embodiment of the invention, the new Web page belongs to a navigation domain D2 distinct from the navigation domain DW of the new work module.

According to another particular embodiment of the invention, the navigation domain D1 of the first Web page is distinct from the navigation domain D2 of the new Web page.

According to a particular embodiment of the invention, the method comprises a step 210 of monitoring in the local database of the end of processing of the data. This monitoring step can be performed on the basis of the instructions and of the remaining data stored in the local database.

According to a variant, the monitoring step is performed on the basis of the information item indicating which instructions and remaining data have to be processed. In this variant, the method comprises an additional step of obtaining from the server belonging to the navigation domain DW, remaining instructions and data to be processed if the information item indicates that the data processing had not terminated during the storage.

In the case where the data processing has terminated (via 211), the method resumes at step 202 of obtaining by the new work module of new instructions and data to be processed.

In the case where the data processing has not terminated (via 212), the method resumes at step 203 of processing the remaining data according to the instructions remaining to be executed, on the basis of the intermediate result stored in the local database.

The steps of storage subsequent to the detection of an interruption at 207, of loading of a new Web page at 208, of loading of a new work module at 209 and of processing at 203 are repeated until the obtaining of a final result obtained when all the instructions of the group of instructions have been executed.

The final result is then dispatched at 205 to the server belonging to the navigation domain DW.

FIG. 3 presents an architecture of a device 30 making it possible to implement the method of processing data in a navigation module according to a particular embodiment of the invention. The device comprising a processing unit 32, equipped for example with a microprocessor (PROC). The processing unit 32 comprises calculation means (PROC) and storage means (MEM) for implementing a software environment. The software environment is typically composed of firmware (in English), of a startup manager or “boot loader” in English, of an operating system comprising software components. By way of nonlimiting example, the operating system may be an operating system for a mobile terminal or for a personal computer.

The software environment implemented by the device 30 is adapted for executing a navigation module, such as the navigation module 17 of FIG. 1. The device 30 furthermore comprises a storage space 33 such as a memory for example making it possible to store the data of the local database of the navigation module 17.

The device also comprises a user interface 34 (INT) allowing the user to interact with the device 30.

The device also comprises a unit for access to a network 31 (COM) allowing for example the device 30 to access the Internet via various communications networks, such as for example a mobile telephone network, a computer network, or a satellite network.

In order to implement the method of processing data by the navigation module, the navigation module loads the program codes of the Web pages and the program codes corresponding to the data processing instructions by virtue of the network interface 31. The software environment implemented by the device 30 is able to interpret and execute the program codes loaded by virtue of the processing unit 32 and of the memory 33.

The device 30 is included in a terminal such as for example a personal computer, fixed or mobile, a mobile telephone, a tablet.

What is claimed is:

1. A method of processing data in a navigation module, the navigation module having a local database allowing recording and access to data recorded by one or more modules suitable for being loaded into the navigation module and belonging to one and the same navigation domain termed the common navigation domain, the method comprising:
loading by the navigation module of a first Web page;
loading into the navigation module of a first work module associated with the first Web page and belonging to the common navigation domain;
obtaining by the first work module of a group of data processing instructions and of a group of data to be processed on the basis of a server belonging to the common navigation domain;
processing by the first work module, according to at least one instruction of the group of instructions of at least one data item of the group of data to be processed;
storage by the first work module, in the local database, of at least one remaining instruction still to be executed and of at least one intermediate result data item obtained by the processing of the at least one data item to be processed;
subsequent to the loading by the navigation module of a new Web page, and to the loading into the navigation module of a new work module associated with the new Web page and belonging to the common navigation domain, processing of the at least one intermediate result data item, according to at least the stored remaining instruction;
the steps of storage, of loading of a new Web page, of loading of a new work module and of processing being repeated until the obtaining of a final result obtained when all the instructions of the group of instructions have been executed and;
dispatching of the final result to the server belonging to the common navigation domain.

2. The method according to claim 1, wherein the first Web page or the new Web page belongs to a navigation domain distinct from the common navigation domain.

3. The method according to claim 1, wherein the first Web page belongs to a navigation domain distinct from the navigation domain of the new Web page.

4. The method according to claim 1, wherein the loading of the first work module is brought about by the presence in the first Web page of a reference to the common navigation domain.

5. The method according to claim 4, wherein the reference to the common navigation domain is contained in another Web page contained in the first Web page, the other Web page containing instructions to be executed by the navigation module allowing the loading of the first work module.

6. The method according to claim 1, wherein the storage step is brought about by the closing of the first Web page in the navigation module or by the closing of the navigation module.

7. The method according to claim 1, further comprising monitoring in the data stored in the local database, of the end of processing according to the at least one instruction, and obtaining by the new work module of at least one new group of processing instructions if the processing according to the group of instruction has terminated.

8. A non-transitory computer-readable medium readable by a processor, the computer-readable medium including computer-implemented instructions that, when executed, perform the method of processing data according to claim 1.

9. A device for processing data in a navigation module, the navigation module having a local database allowing recording and access to data recorded by one or more modules suitable for being loaded into the navigation module and belonging to one and the same common navigation domain, the device comprising:
means for loading by the navigation module of a Web page,
means for loading into the navigation module of a work module associated with the Web page and belonging to the common navigation domain,
means for obtaining by the work module of a group of data processing instructions and of a group of data to be processed on the basis of a server belonging to the common navigation domain,
means for processing by the work module, according to at least one instruction of the group of instructions of at least one data item of the group of data to be processed,
means for storage by the work module, in the local database, of at least one remaining instruction still to be executed and of at least one intermediate result data item obtained by the processing of the at least one data item to be processed,
means for processing the at least one intermediate result data item, according to at least the stored remaining instruction, subsequent to the loading by the navigation module of a new Web page, and to the loading into the navigation module of a new work module associated with the new Web page and belonging to the common navigation domain,
means for repeating the steps of storage, of loading of a new Web page, of loading of a new work module and of processing until the obtaining of a final result obtained when all the instructions of the group of instructions have been executed and,
means for dispatching the final result to the server belonging to the common navigation domain.

10. A device for processing data in a navigation module, the navigation module having a local database allowing recording and access to data recorded by one or more modules suitable for being loaded into the navigation module and belonging to one and the same common navigation domain, the device comprising:
a component configured to load by the navigation module of a Web page;
a component configured to load into the navigation module of a work module associated with the Web page and belonging to the common navigation domain;
a component configured to obtain by the work module of a group of data processing instructions and of a group of data to be processed on the basis of a server belonging to the common navigation domain;
a component configured to process by the work module, according to at least one instruction of the group of instructions of at least one data item of the group of data to be processed;
a component configured to store by the work module, in the local database, of at least one remaining instruction still to be executed and of at least one intermediate result data item obtained by the processing of the at least one data item to be processed;
a component configured to process the at least one intermediate result data item, according to at least the stored remaining instruction, subsequent to the loading by the navigation module of a new Web page, and to the loading into the navigation module of a new work module associated with the new Web page and belonging to the common navigation domain;
a component configured to repeat the steps of storage, of loading of a new Web page, of loading of a new work module and of processing until the obtaining of a final result obtained when all the instructions of the group of instructions have been executed; and
a component configured to dispatch the final result to the server belonging to the common navigation domain.
